(19) United States
(12) Patent Application Publication
(10) Pub. No.: US 2022/0141172 A1
(43) Pub. Date: May 5, 2022

(54) VERIFICATION ASSOCIATED WITH A DOMAIN NAME

(71) Applicant: NUM Technology Ltd, London (GB)

(72) Inventor: Elliott Michael BROWN, London (GB)

(21) Appl. No.: 17/521,650

(22) Filed: Nov. 8, 2021

Related U.S. Application Data
(63) Continuation of application No. PCT/GB2020/051113, filed on May 6, 2020.

(30) Foreign Application Priority Data
May 9, 2019 (GB) 1906535.8

(51) Int. Cl. H04L 51/48; H04L 51/23; H04L 9/32

(52) U.S. Cl. CPC H04L 51/28; H04L 9/3239; H04L 51/30

(57) ABSTRACT

Verification associated with a domain name is performed using a hierarchical domain name system. A domain name system query comprising the domain name is transmitted via a network. A response to the domain name system query is received via the network. The response comprises first data. Input data is received via the network. A hash function is used to map the input data received via the network to second data. The second data comprises hashed data. A result of a verification associated with the domain name is determined based on a comparison involving the first data and the second data.

### CROSS-REFERENCE TO RELATED APPLICATIONS

This application is a continuation of International Application No. PCT/GB2020/051113, filed May 6, 2020 which claims priority to GB Application No. GB1906535.8, filed May 9, 2019, under 35 U.S.C. § 119(a). Each of the above-referenced patent applications is incorporated by reference in its entirety.

### BACKGROUND

### Technical Field

The present disclosure relates to verification associated with a domain name.

### Background

A verifying entity (for example, a service provider) may perform verification associated with a domain name by generating a random string, requesting an entity with authority over the domain name to add a Hypertext Markup Language (HTML) comment or meta tag including the random string to a homepage for the domain name, and verifying that the random string has been added by inspecting the homepage. This is described, for example, in International patent application no. PCT/GB2016/054051, the entire contents of which are incorporated herein by reference.

A hierarchical domain name system, such as the Domain Name System (DNS), may also be used to perform verification associated with a domain name. This may involve communication of less data than where webpages are used to perform verification. For example, a verifying entity (such as a service provider) may request a user to verify a domain name before providing services related to the domain name. To verify the domain name, the service provider may generate an authorization code for the domain name and request the user to store the authorization code in a DNS resource record in a zone file for the domain name. In one known example, the authorization code comprises a Globally Unique IDentifier (GUID), such as a 128-bit code generated by combining a local Ethernet serial number with a date and time. In another known example, the authorization code comprises a hash of a combination of (i) a user account ID number, (ii) a domain name being validated, and (ii) a unique secret known only to the verifying entity. Once the user confirms that the authorization code has been stored in the zone file for the domain name, the service provider performs a DNS query for the domain name and checks whether the response to the DNS query includes the expected authorization code. If so, the service provider can determine that the user has authority in relation to the domain name and can perform verification in associated with the domain name accordingly. The reader is referred to US Patent Application Publication Number US 2007/067465 A1 in this regard.

### SUMMARY

According to first embodiments, there is provided a method of performing verification associated with a domain name using a hierarchical domain name system, the method comprising:

transmitting, via a network, a domain name system query comprising the domain name;

receiving, via the network, a response to the domain name system query, the response comprising first data;

receiving, via the network, input data;

using a hash function to map the input data received via the network to second data, the second data comprising hashed data; and

determining a result of a verification associated with the domain name based on a comparison involving the first data and the second data.

According to second embodiments, there is provided a method comprising:

receiving, via a network, a domain name system query comprising a domain name; and

transmitting, via the network, a response to the domain name system query, the response comprising first data to enable a recipient of the response to determine a result of a verification associated with the domain name based on a comparison involving the first data and second data, the second data being obtained by using a hash function to map input data received via the network to the second data, the second data comprising hashed data.

In the second embodiments, the domain name system query may be received from a first service provider apparatus, wherein the response is transmitted to the first service provider apparatus, and the method may comprise:

receiving, from a second, different service provider apparatus, a domain name system query comprising the domain name; and

transmitting, to the second service provider apparatus, a response to the domain name system query received from the second service provider apparatus, the response message transmitted to the second service provider apparatus comprising the first data

According to third embodiments, there is provided a method comprising:

transmitting a domain name system query comprising a domain name; and

receiving, in response to the domain name system query, a response comprising verification data, wherein the verification data comprised in the response is not comprised in the domain name system query and wherein the verification data comprises hashed data. The verification data may be shared verification data. The hashed data may have been derived by non-secret input data having been hashed.

According to fourth embodiments, there is provided a method comprising:

storing verification data for performing verification associated with a first domain name in a zone file for a second, different domain name, the second domain name comprising:

the first domain name; and

at least one label preceding the first domain name and/or at least one label following the first domain name.

According to fifth embodiments, there is provided a method comprising:

mapping contact information associated with an entity associated with a domain name onto hashed data using a hash function; and

causing the hashed data to be stored as verification data in a zone file for the domain name.

According to sixth embodiments, there is provided a method comprising:

receiving, from a first service provider apparatus, a first domain name system query comprising a domain name;

transmitting, to the first service provider apparatus, a first response in response to the first domain name system query, the first response comprising verification data, the verification data having been derived deterministically based on:

an identifier associated with an entity associated with the domain name; and/or data provided by the entity associated with the domain name to another entity;

receiving, from a second, different service provider apparatus, a second domain name system query comprising the domain name; and

transmitting, to the second service provider apparatus, a second response in response to the second domain name system query, the second response comprising the verification data.

According to seventh embodiments, there is provided apparatus arranged to perform a method according to any of the first through sixth embodiments.

According to eighth embodiments, there is provided a computer program arranged, when executed, to perform a method according to any of the first through sixth embodiments.

According to ninth embodiments, there is provided a computer-readable medium comprising a computer program according to the eighth embodiments.

Further features and advantages will become apparent from the following description, given by way of example only, which is made with reference to the accompanying drawings.

### BRIEF DESCRIPTION OF THE DRAWINGS

FIG. 1 shows a schematic block diagram of an example of a hierarchical domain name system;

FIG. 2 shows a schematic block diagram of an example of a data communications network in accordance with embodiments;

FIG. 3 shows a schematic block diagram of another example of a data communications network in accordance with embodiments;

FIGS. 4A and 4B show a sequence diagram illustrating an example of a method in accordance with embodiments; and

FIG. 5 shows a schematic block diagram of an example of an apparatus in accordance with embodiments.

### DETAILED DESCRIPTION

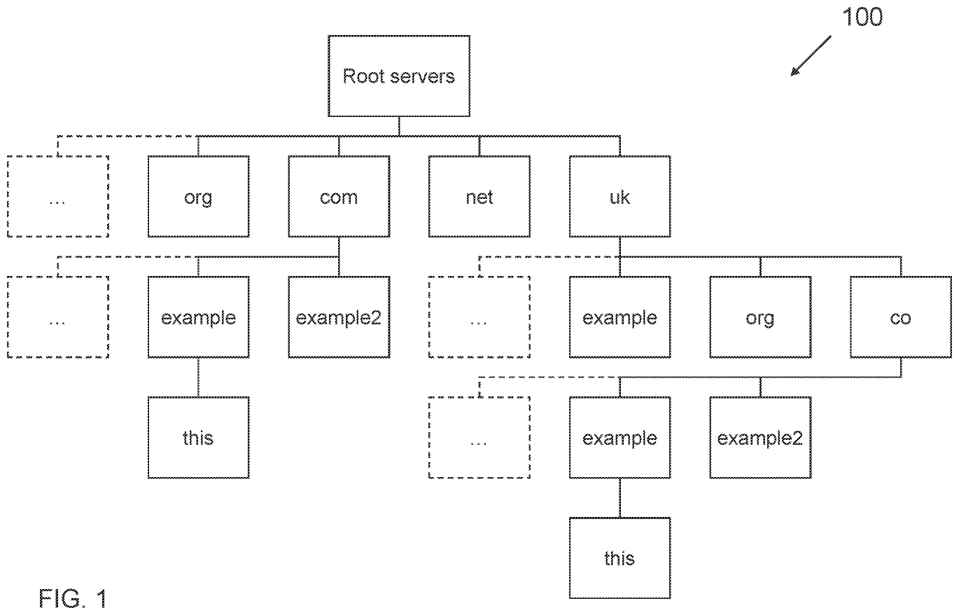

Referring to FIG. 1, there is shown schematically an example of a hierarchical domain name system 100. In this example, the hierarchical domain name system is the DNS.

The DNS is a global, distributed, hierarchical naming system for resources connected to computer networks. DNS is detailed, for example, in IETF RFC 1034 and 1035. One function of the DNS is to translate human-friendly domain names into machine-friendly Internet Protocol (IP) addresses. For example, the DNS may translate a human-friendly domain name of “example.com” into a machine-friendly IP address of 123.45.67.89. The DNS serves as the directory service of the Internet.

Every domain name on the Internet is part of the DNS. The DNS is the cornerstone of the Internet and was created to make the Internet easier to use. The DNS translates easy-to-remember domain names into IP addresses of IP devices, such as servers. The DNS is used every day by billions of people. The DNS is used each time someone enters a domain name into their web browser. The DNS tells a web browser which web server to go to when a website, for example “example.com”, is requested, for example on a computer or smartphone.

Every domain name is hosted on a DNS server. There are many thousands of DNS servers operating worldwide. Information about a domain name is stored in a zone file on a DNS server. A zone file contains DNS resource records. The DNS is made up of name servers that hold information about domain names in DNS zones. Information for each domain name is held in a zone file. Included within the zone file are DNS resource records.

At the highest level of the DNS hierarchy are the root name servers. The root name servers list the authoritative name servers for top-level-domains (TLDs). Examples of TLDs include, but are not limited to, “com” and “uk”.

In the domain name “this.example.com”, the following are all domain names: “this.example.com”, “example.com” and “com”. “com” is a TLD. In addition to being a domain name, “example.com” is a sub-domain of the TLD “com”, and “this.example.com” is a sub-domain of the domain name “example.com”. Each of the parts of a domain name separated by a dot is called a label. In the domain name “this.example.com”, “this”, “example” and “com” are labels.

In the domain name “this.example.co.uk”, the following are all domain names: “this.example.co.uk”, “example.co.uk”, “co.uk” and “uk”. “uk” is a country code TLD (ccTLD). In addition to being a domain name, “co.uk” is a sub-domain of the ccTLD “uk”, “example co.uk” is a sub-domain of the domain name “co.uk” and “this.example.co.uk” is a sub-domain of the domain name “example.co.uk”. In the domain name “this.example.co.uk”, “this”, “example”, “co” and “uk” are labels.

A TLD (or “name space”) is managed by a Domain Registry (hereinafter “Registry”). For example, VeriSign® is the Registry that manages the “com” name space. Nominet® is the Registry that manages the “uk” name space. Some Registries have split their domain name into sub-domains. For example, Nominet has split their TLD “uk” into “co.uk”, “org.uk”, “me.uk” and others. Nominet allows the creation of domain names at the second level under “uk” in the format of “example.uk”. Creating new domains within a name space is known as a domain name registration.

Although domain names can sometimes be registered directly through Registries, this is discouraged and registration of domain names within the Registry name space is typically through Domain Registrars (hereinafter “Registrars”). A person registering a domain name (e.g. “example.com”) through a Registrar is known as a Registrant. A registrant is allowed to set up further domain names (a sub-domain) within their domain (e.g. this.example.com).

Every domain name has an authoritative name server. An authoritative name server is the name server that holds the current DNS resource records for the domain name. There are various types of DNS resource record. One type of resource record is a Name Server (NS) record. An NS resource record is used to delegate authority for a DNS zone to another name server. The most common DNS resource record is an “A” record. An A record is used to direct website requests to IP addresses. There are other DNS resource record types including, but not limited to, Mail Exchange (MX) records for e-mail, records for free text (TXT) along with other record types.

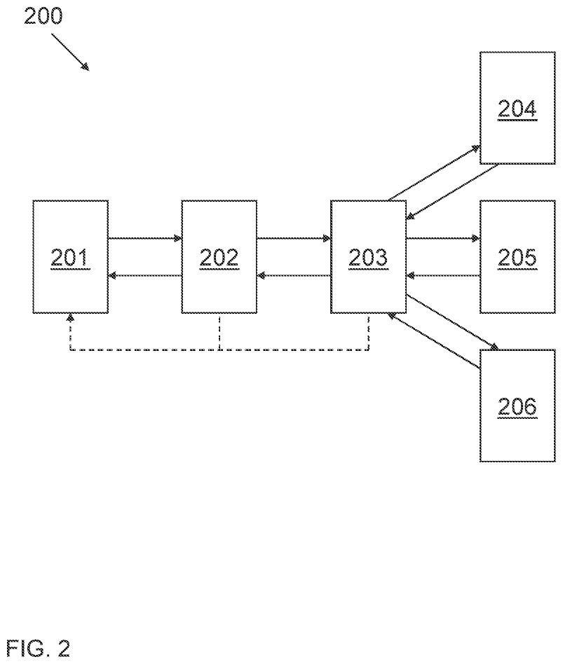

Referring to FIG. 2, there is shown schematically an illustration of an example of a data communications network 200.

The data communications network 200 includes a user device 201. The user device is associated with a user. Examples of user device 201 include, but are not limited to, a smartphone, a tablet computing device, a laptop computer, a desktop computer, a satellite navigation device, an in-vehicle entertainment system and a smart television. The data communications network 200 also includes a local network 202. The local network 202 includes one or more components. An example of a component of the local network 202 is a router. The communications network 200 also includes a DNS resolver 203 at an Internet Service Provider (ISP) of the user. The communications network 200 also includes a root server 204. The communications network 200 also includes a registry name server 205. In this example, the registry name server 205 is an authoritative name server of the top-level domain name “com”. The communications network 200 also includes a registrant name server 206. In this example, the registrant name server 206 is an authoritative name server of the domain name “example.com”.

The process of finding DNS resource records for a domain name is known as DNS resolution or domain name resolution. DNS resolvers are used for this purpose. DNS resolvers determine the authoritative name servers for a given domain name by resolving the full domain name starting with the right-most label and working to the left-most label in the domain name.

In this example, a user enters the domain name “example.com” into a web browser on their user device 201.

If the domain name has been resolved recently, DNS resource records previously retrieved for the domain name will be stored in the user device 201 DNS cache or in the local network 202 DNS cache and will be returned to the user device 201.

If the domain name “example.com” has not been resolved recently, for example if an IP address for the domain name “example.com” is not cached in the local network 202, then the DNS query is passed to the DNS resolver 203.

In this example, the DNS resolver 203 performs recursive DNS lookups, starting with the label “com”. The DNS resolver 203 resolves the domain name starting with the right-most label first and requests the IP address for the authoritative name server 205 for the “com” TLD from the root server 204. The IP address for the authoritative name server 205 for the “com” domain name is returned from the root server 204.

The DNS resolver 203 queries the authoritative name server 205 for the domain name “com” for the IP address of the authoritative name server 206 of the domain name “example.com”.

The authoritative name server 205 for the domain name “com” returns the IP address of the authoritative name server 206 for the domain name “example.com” to the DNS resolver 203. In this example, the authoritative name server 206 for the domain name “example.com” is the name server elected by the Registrant of the domain name “example.com” when they registered their domain name “example.com”.

As the DNS resolver 203 has reached the left-most label of the domain name “example.com”, the DNS resolver 203 requests the DNS resource records for the domain name “example.com” from the authoritative server 206 for the domain name “example.com”. The DNS resolver 203 returns an error if no resource records were found.

Assuming resource records were found for the domain name “example.com”, an IP address of a web server associated with the domain name “example.com” is returned to the DNS resolver 203 in the resource records for the domain name “example.com”. The DNS resolver 203 caches the resource records.

The DNS resolver 203 returns the resource records to the local network 202. The local network 202 caches the resource records.

The local network 202 returns the resource records to the user device 201. The user device 201 caches the resource records. The web browser running on the user device 201 sends a request to the IP address for the web server associated with the domain name “example.com” over Hypertext Transfer Protocol (Secure) (HTTP(S)) for website HTML content for the domain name “example.com”. The IP address for the web server associated with the domain name “example.com” was included in the resource records returned by the DNS resolver 203.

As indicated above, the resource records retrieved for the domain name “example.com” are cached on the user device 201, in the local network 202 and by the DNS resolver 203 for a specified time. The specified time is determined by a Time-to-live (“TTL”) setting of the resource record that was returned.

A DNS query is often sent to a name server using User Datagram Protocol (UDP) on port 53. A DNS query can also travel over Transmission Command Protocol (TCP). DNS over HTTP (DoH) enables a client to send a DNS query to a resolver over HTTP or HTTPS. A response to a DNS query from a name server includes an answer to the query. The answer comes from a DNS zone file, which lists the resource records for the domain name. Every domain name is listed in an associated zone file; even TLDs.

The format of a DNS zone file is defined in RFC 1035 (section 5) and RFC 1034 (section 3.6.1). This format was originally used by the Berkeley Internet Name Domain (BIND) software package, but has been widely adopted by other DNS servers. A zone file is a sequence of entries of resource records. Each line in the zone file is a text description that defines a single resource record. The text description comprises several fields separated by white space as follows:

| | | | | |
|---|---|---|---|---|
| NAME | TTL | CLASS | TYPE | DATA |

An example entry in a zone file for the example domain name “example.com” is:

| NAME | TTL | CLASS | TYPE | DATA |
|---|---|---|---|---|
| example.com. | 270 | IN | A | 123.45.67.89 |

The TTL value indicates how long the record should be cached for, which, in this example, is 270 seconds.

An example of a DNS query for any DNS resource record type for the example domain name “example.com” generated using the “dig” command line tool is:

dig example.com ANY

Many nameservers do not respond to DNS queries requesting “ANY” type of resource record. For such nameservers, a resource record type is to be specified.

An example of a response received from a name server for the domain name “example.com” is:

| | | | | |
|---|---|---|---|---|
| example.com. | 270 | IN | A | 123.45.67.89 |
| example.com. | 194 | IN | MX | 10 mailserver.com |
| example.com. | 91816 | IN | NS | ns1.nameserver.com. |
| example.com. | 91816 | IN | NS | ns2.nameserver.com. |
| example.com. | 1840 | IN | TXT | “v=spf1 ip4 123.45.67.89 -all” |

In this example, the DNS query for the domain name “example.com” has returned five resource records. Each resource record is displayed on its own line. The first resource record, displayed on the first line, is an A record showing the IP address of the server that handles HTTP and HTTPS requests. The second resource record, displayed on the second line, is an MX resource record with a priority of “10” showing that e-mail is handled by “mailserver.com”. The third and fourth resource records, shown on the third and fourth lines, are NS records which show that the authoritative name servers for the domain name are “ns1.nameserver.com” and “ns2.nameserver.com”. The final resource record on the fifth line is a TXT record in a Sender Policy Framework (“SPF”) format.

SPF is an established way to tackle spam. SPF allows domain name owners to list servers that are allowed to send e-mail on behalf of the domain name. The SPF record in the example above means that the only IP address allowed to send e-mail on behalf of the domain name “example.com” is the IP address 123.45.67.89. The final part “-all” means that e-mail from all other IP addresses should be treated as spam. Recipient e-mail servers check the SPF record when receiving e-mail from a domain name and follow the guidance in the SPF to help filter and block spam e-mail.

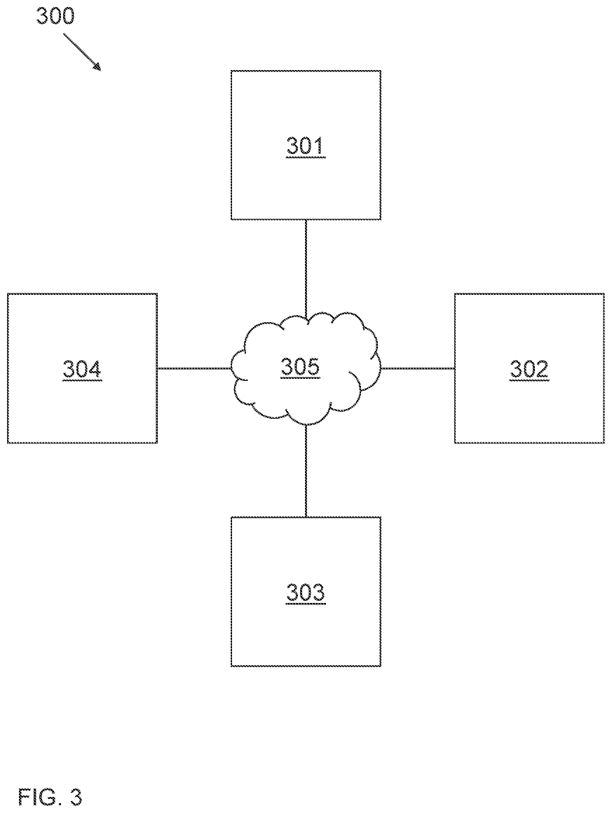

Referring to FIG. 3, there is shown schematically a block diagram of an example of a data communications network 300. The data communications network 300 may be used to process data in the manner described in detail herein. In accordance with some examples described herein, such data processing comprises performing verification associated with a domain name and/or enabling such verification to be performed. Performing verification may result in a positive or negative verification result.

In this example, the data communications network 300 comprises a first apparatus 301, a second apparatus 302, a third apparatus 303 and a fourth apparatus 304. In this example, the four apparatuses 301, 302, 303, 304 are interconnected via a network 305. In this example, the network 305 comprises a computer network. In this example, the computer network 305 is the Internet. In this example, the first apparatus 301 comprises a user device. In this example, the second apparatus 302 comprises a name server. In this example, the third apparatus 303 comprises a first service provider apparatus, which is associated with a first service provider. In this example, the fourth apparatus 304 comprises a second service provider apparatus, which is associated with a second service provider. The techniques described herein may, however, be implemented in a data communications network having a different configuration from that of the example data communications network 300.

Examples described herein enhance verification associated with a domain name using a hierarchical domain name system. In some examples, verification involves determining whether or not an entity has authority in relation to the domain name. The entity may be a user asserting that they have authority in relation to the domain name Verification may therefore involve determining whether or not the user asserting that they have authority in relation to the domain name does, in fact, have authority in relation to the domain name. This may be determined using contact information provided by the entity and/or other input data. In some examples, verification involves determining whether or not information purported to be associated with the domain name is in fact associated with the domain name. As such, different types of verification associated with a domain name may be performed in accordance with examples described herein.

In some examples, different service providers use the same verification data as each other to perform verification associated with a given domain name Such verification data may therefore be considered to be “shared” verification data in that the same verification data can be used by multiple different service providers. As such, shared verification data may be considered to be data useable by multiple different verifying entities (for example, service providers) to perform verification associated with the given domain name. Using shared verification data differs from known techniques in which different service providers generate and use different, respective authorization codes. The authorization codes would be different in known techniques where, for example, each service provider generates an authorization code based on a unique secret known only to that service provider. By using shared verification data, the amount of data stored, processed and communicated in the DNS may be reduced, while still enabling verification to be performed. This can enable more scalable verification using the DNS, particularly where relatively large numbers of service providers perform verification associated with a given domain name and/or where the verification data includes a relatively large number of characters. In particular, DNS TXT resource records, which in accordance with some examples store the shared verification data, are limited to 255 characters. Using shared verification data in accordance with some examples described herein may enable fewer resource records to be used for verification purposes relative to the number of resource records used where different authorization codes are used for different service providers, in particular where there are a relatively large number of service providers and/or where the authorization codes are relatively long.

In some examples, the verification data is derived deterministically. As such, rather than verification data being generated randomly (as may be the case in some known systems), the verification data is derived such that given input data always maps to the same given output data. In contrast to generating a random authorization code for each domain name and storing the randomly generated authorization code in connection with the domain name, in accordance with examples described herein, a service provider (and/or any other verifying entity performing verification) can perform verification in a more ‘on-the-fly’ manner by generating the output data used to perform verification ‘on-demand’ in response to receiving the input data used to derive the output data deterministically. This can reduce the amount of storage used to perform verification compared to a randomly generated authorization code being stored.

In some examples, the verification data comprises hashed data. Hashed data differs from plaintext data and encrypted data. Plaintext data does not provide any security or privacy in relation to the plaintext data. Encrypting plaintext data to generate encrypted data provides a degree of security and privacy in relation to the plaintext data, but encrypted data is nevertheless intended to be decrypted using a decryption key such that the encryption can, in effect, be reversed and the plaintext data recovered. Hashed data may be generated by using a hash function to map input data to hashed data. In the context of a hash function, the term “input data” as used herein indicates all of the data that is mapped to the hashed data. The input can, in some examples, comprise multiple components. A hash function may map input data of any size onto hashed data of a fixed size. A hash function is effective in accordance with some examples described herein in which the input data to the hash function is not of a fixed size. A hash function is deterministic. As such, a given hash function always maps given input data to the same given hash data. This is effective in accordance with some examples described herein in which given input data is hashed multiple times using the same hash function and correspondence between the resulting hashed data is used to perform verification. In some examples, the hash function is a cryptographic hash function. A cryptographic hash function readily enables verification of whether given input data maps onto given hashed data. However, obtaining input data from given hashed data using a cryptographic hash function is, intentionally, difficult. This can provide security in relation to the input data. This can be particularly, but not exclusively, effective where the input data comprises confidential information, personal information, sensitive information etc. Examples of cryptographic hash functions include, but are not limited to, SHA-1, SHA-2, SHA-3 and MD5.

In some examples, verification data used for such verification is stored in a zone file for a given domain name. In some such examples, the given domain name is the domain name in association with which verification is being performed. In other examples, the given domain name is different from, but includes, the domain name in association with which verification is being performed. Storing the verification data in a zone file for a domain name other than the domain name in association with which verification is being performed may reduce the likelihood of unintended modifications being made to the zone file for the domain name in association with which verification is being performed. For example, if the verification data used for performing verification associated with the example domain name “example.com” is stored in a zone file for the domain name “example.com”, there is a risk of other data stored in the zone file for the domain name “example.com” being modified, inadvertently, in an undesirable way in the process. Further, by using shared verification data, the verification data can be stored in the zone file for the domain name “example.com” fewer times (for example, only once) than where different authorization codes are used for each service provider. For example, storing (different) authorization codes for four different service providers, for example, may involve four modifications to the zone file for the domain name “example.com”, potentially at four separate times, whereas using shared verification data may involve only one modification. Fewer modifications can reduce the likelihood of errors in the zone file. Further, where the authoritative name server for the given domain name is different from the authoritative name server for the domain name in association with which verification is being performed, the authoritative name server for the domain name in association with which verification is being performed may be relieved from handling requests relating to verification. For example, the authoritative name server for the example domain name “example.com” can continue to handle conventional requests associated with that domain name, whereas requests associated with verification may be handled by a different name server.

In some examples, and as will be described in more detail below, a user supplies a domain name (for example “example.com”) and an input value (for example “inputstring”) to a service provider. The service provider performs a hash function (for example, using the SHA-1 algorithm) on the input value and runs a DNS query for the domain name. If the returned hash value (namely, the hash value resulting from the hashing performed by the service provider) matches a string found in the DNS response, this verifies that the input value is associated with the domain name In some examples, the input value comprises an identifier for the user (for example, an e-mail address, telephone number, etc). In some examples, the input value comprises data that an entity associated with the domain name has shared with the user (for example, bank details, company details, address details, etc). The entity associated with the domain name may be a Registrant of the domain name, an owner of the domain name, etc.

Some examples described herein correspond to proving authority for a domain name. In some examples, an identifier for an entity is hashed and is associated with a DNS zone representing the entity. For example, a DNS TXT resource record may be created to store an identifier (for example, an e-mail address) of an entity (for example, a person) in hashed form. Once created, anyone may be able to check if a particular e-mail address is authorised to act on behalf of a domain.

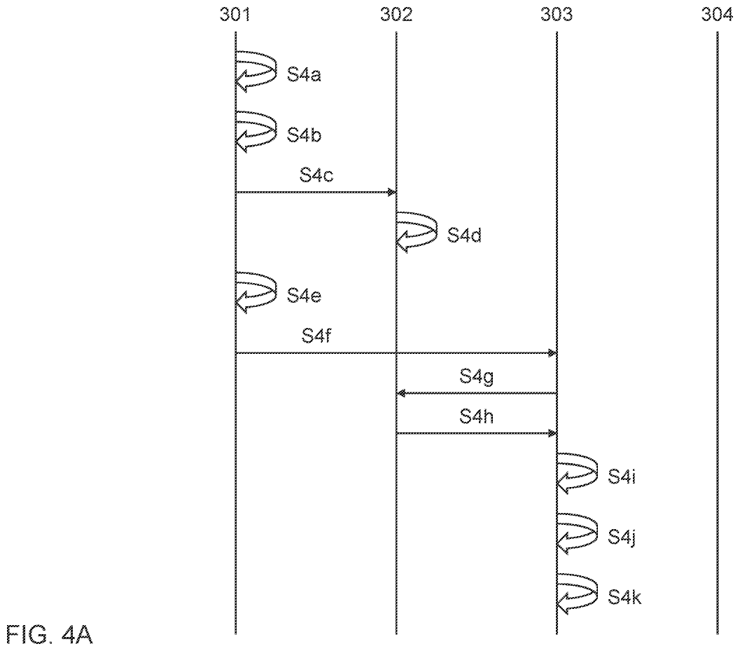

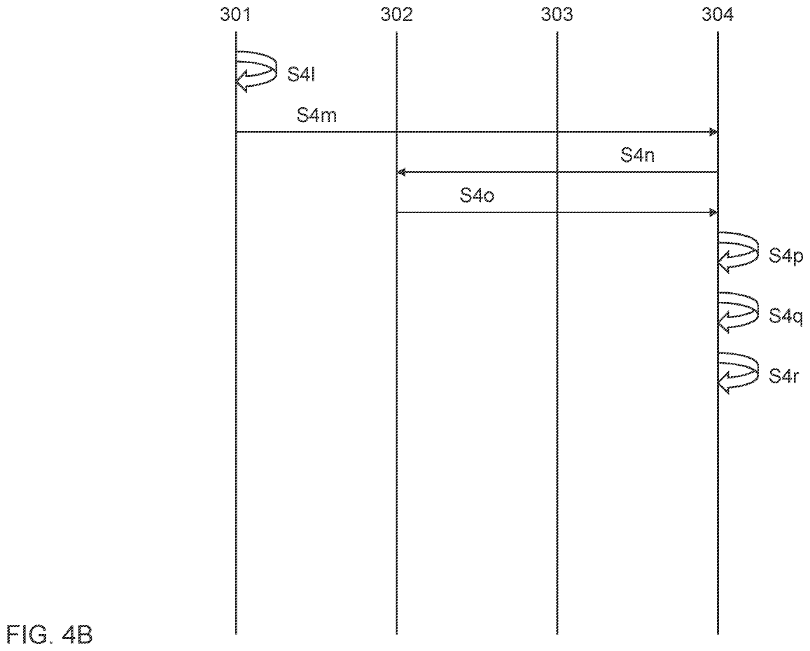

Referring to FIG. 4, there is shown an example of a method 400 of performing verification in a hierarchical domain name system. In this example, the domain name system comprises the DNS. In this example, the method 400 enables domain name verification to be performed in the example data communications network 300 described above with reference to FIG. 3. In this example, the method 400 corresponds to a user of the user device 301 enabling the first and second service provider apparatuses 303, 304 to perform verification associated with a domain name using contact information of the user. In this example, the first and second service provider apparatuses 303, 304 receive the contact information from the user device 301 via the network 305. In this specific example, the domain name is “example.com” and the contact information is the e-mail address of the user “username@example.com”. In this specific example, the name server 302 is the authoritative name server for “example.com”.

At item S4a, the user device 301 obtains the e-mail address. The user device 301 may obtain the e-mail address in various different ways. For example, the user may enter the e-mail address via a user interface of the user device 301, the user device 301 may retrieve the e-mail address from memory of the user device 301, the user device 301 may obtain the e-mail address from a remote source, etc.

At item S4b, the user device 301 hashes the e-mail address using a hash function. In this example, the hash function is SHA-1, which maps the input data “username@example.com” to hashed data “59614f92093fc9fef50673bc160fd808623b17bd”. In this example, the hashed data obtained at item S4b corresponds to first data as described herein. As indicated above, in this example, the input data to the hash function corresponds to all of the data, in this example only the e-mail address, that is mapped onto the hashed data. If, in another example, the e-mail address were combined with other data (for example, a telephone number) and the combination of the e-mail address and telephone number were hashed, then the input data would correspond to the combination of the e-mail address and telephone number (i.e. all of the data being hashed). In this example, the first data is useable by the first and second service provider apparatuses 303, 304 to perform verification associated with the domain name. As such, in this example, the first data corresponds to shared verification data, as opposed to service-provider-specific authorization codes.

At items S4c and S4d, the user device 301 causes the first data to be stored by the authoritative name server 302 in a zone file for the domain name. This may, for example, involve the user editing the zone file via the user device 301 and adding the first data to the zone file, or otherwise. In this example, the first data is stored in a TXT resource record in the zone file. In this example, the first data is stored as a separate TXT resource record from the TXT resource in the SPF format. For example, the user may create a new TXT resource record specifically for the first data.

As such, in this example, contact information (namely, the e-mail address “username@example.com”) associated with an entity (namely, the user) associated with a domain name (namely, the domain name “example.com”) is mapped (at item S4b) onto hashed data (namely, the first data) using a hash function (namely, SHA-1) and the hashed data is caused to be stored (at items S4c and S4d) in a zone file for the domain name.

At item S4e, the user device 301 obtains the e-mail address and the domain name. The user device 301 may obtain the e-mail address and the domain name in various different ways. For example, the user device 301 may have already obtained one or both of the e-mail address and the domain name from the user. Alternatively or additionally, the user device 301 may prompt the user for one or both of the e-mail address and the domain name at item S4e.

At item S4f, the user device 301 transmits the e-mail address and the domain name to the first service provider apparatus 303 via the network 305. In this example, the user device 301 does not transmit the first data to the first service provider apparatus 303 at item S4f. As such, in this example, the first service provider apparatus 303 receives the e-mail address and the domain name from the user device 301 via the network 305. This differs from the first service provider apparatus 303 obtaining the e-mail address and the domain name in another manner, such as the first service provider apparatus 303 generating the e-mail address and the domain name.

While, in this example, the first service provider apparatus 303 receives the e-mail address and the domain name from the user device 301 via the network 305 after the e-mail address has been hashed (item S4b) and the first data has been stored by the authoritative name server 302 (items S4c, S4d), the first service provider apparatus 303 could receive the e-mail address and the domain name at a different time, for example before the e-mail address has been hashed (item S4b) and/or the first data has been stored by the authoritative name server 302 (items S4c, S4d). Further, while, in this example, the first service provider apparatus 303 receives the e-mail address and the domain name together, the e-mail address and the domain name could be received separately in other examples.

The e-mail address and the domain name are known to at least one entity in addition to the first service provider apparatus 303 (and the service provider associated with the first service provider apparatus 303). In particular, the e-mail address and the domain name are known to the user of the user device 301 and, as will be described below, the second service provider apparatus 304. The e-mail address and the domain name may be known to one or more further entities. Examples of such further entities include, but are not limited to, hosting companies, the public, Registrars etc. In this example, the first service provider apparatus 303 verifies the e-mail address received, from the user device 301, via the network 305, at item S4f.

In this example, verifying the e-mail address corresponds to the first service provider apparatus 303 verifying that the user is in control of the e-mail address. More generally, verifying contact information may correspond to verifying that an entity providing the contact information is in control of the contact information. For example, the first service provider apparatus 303 may cause an e-mail with a verification link to be transmitted to the e-mail address. Upon the user following the verification link, the first service provider apparatus 303 can verify that the user is in control of the e-mail address. In this example, the verification associated with the domain name is dependent on verifying the e-mail address. In this example, if the e-mail address is not successfully verified, then the verification associated with the domain name fails. In this example, if the e-mail address is successful, then the verification associated with the domain name can succeed, but at least one further check is made as described below. Where, for example, the contact information comprises a telephone number of the user, verification of the telephone number may involve the first service provider apparatus 303 causing an automated call to be placed to the user with a verification number, a Short Messaging Service (SMS) message to be sent to the user with the verification number, etc. Upon the user providing the same verification number back to the first service provider apparatus 303, responding to the SMS message with a predetermined response etc, the first service provider apparatus 303 can verify the telephone number on the basis that the user is in control of the telephone number.

At item S4g, the first service provider apparatus 303 transmits, and the authoritative name server 302 receives, a DNS query comprising the domain name via the network 305. Although in this example, the authoritative name server 302 receives the DNS query from the first service provider apparatus 303, the authoritative name server 302 may not receive the DNS query from the first service provider apparatus 303. For example, where a response to the DNS query has previously been cached, a cached version of the response may be returned to the first service provider apparatus 303. The cached version of the response may correspond to a response to a previous DNS query from the first service provider apparatus 303 or may correspond to a response to a previous DNS query from other apparatus in the network 300.

In this example, the DNS query of item S4g is for the domain name. In this example, the first service provider apparatus 303 requests only TXT resource records, as opposed to any type of resource record. This may be achieved by the first service provider apparatus 303 including the resource record type identifier “TXT” in the DNS query. Requesting only TXT resource records allows the DNS query and response to be handled relatively quickly compared to any type of resource record being requested. Also, less data is communicated via the DNS by requesting TXT resource records only. Since the data used by the first service provider apparatus 303 to perform verification is in TXT resource records only, verification may still be performed while limiting data usage in the DNS. An example form of the DNS query of item S4g, which includes the domain name (example.com) is:

dig example.com TXT

At item S4h, the authoritative name server 302 transmits, and the first service provider apparatus 303, receives a response to the DNS query of item S4g via the network 305. As indicated above, in examples in which a previous response to a DNS query for the domain has been cached, the first service provider apparatus 303 may receive the response to the DNS query of item S4g from elsewhere in the network 300.

The response of item S4h comprises the domain name. The DNS response of item S4h also comprises the first data. In this example, the first data comprises the hashed data. If the hashed data has not been stored in the zone file for the domain name, then the response of S4h would not comprise the hashed data. As such, in some examples, the response of S4h does not comprise the hashed data and, as such, the verification will fail. It is, however, assumed hereinafter that that first data does comprise the hashed data and may therefore be referred to as “first hashed data”. The DNS response of item S4h may comprise other data. Such other data may comprise SPF data, existing, service-provider-specific authorization codes, etc. In this example, only TXT resource records are returned since only TXT resource records were requested at item S4g. In this example, since the zone file for the domain name comprises a TXT resource record with SPF data, in addition to the TXT resource record with the first hashed data, the response of item S4h comprises both TXT resources records. An example form of the response of item S4h, which includes the domain name (example.com) and the first hashed data, is:

| | | | | |
|---|---|---|---|---|
| example.com. | 1840 | IN | TXT | “v=spf1 ip4 123.45.67.89 -all” |
| example.com. | 3600 | IN | TXT | “59614f92093fc9fef50673bc160fd808623b17bd” |

The TXT resource record comprising the first hashed data may comprise an identifier in addition to the first hashed data to indicate that the first hashed data corresponds to verification data. For example, the TXT resource record comprising the first hashed data may be of the following form, where “u=” indicates verification data:

example.com. 3600 IN TXT “u=59614f92093fc9fef50673bc160fd808623b17bd”

As such, in this example, a domain name system query comprising a domain name (namely, “example.com”) is transmitted (at item S4g) and a response comprising hashed data (namely, the first hashed data) is received (at item S4h), whether from the authoritative name server 302 or otherwise, in response to the domain name system query. The hashed data (namely, the first hashed data) comprised in the response is not comprised in the domain name system query.

At item S4i, the first service provider apparatus 303 hashes the e-mail address (which the first service provider apparatus 303 received from the user device 301 via the network 305 at item S4f) using SHA-1 to mirror the hash function used by the user device 301. The user device 301 may indicate to the first service provider apparatus 303 which hash function should be used by the first service provider apparatus 303. The hash function to be used may be included in the resource record itself. For example, the resource record may indicate that the hashed data has been derived from an e-mail address using SHA-1 by including “hash=SHA1;type=email;hashed=59614f92093fc9fef50673bc160fd808623b17bd”. In such an example, the user device 301 indirectly indicates to the first service provider apparatus 303 which hash function should be used. In other examples, the user device 301 can indicate the hash function to be used to the first service provider apparatus 303 directly.

Alternatively, or additionally, the hash function to be used may be predetermined. For example, the first service provider apparatus 303 may be configured always to use SHA-1 on the basis that the first hashed data will have been derived using SHA-1. In this example, item S4i maps the input data “username@example.com” to the hashed data “59614f92093fc9fef50673bc160fd808623b17bd”. In this example, the hashed data of item S4i corresponds to second data, which comprises hashed data. In this example, the second data comprises only the hashed data and no other data. The second data may be referred to hereinafter as “second hashed data” accordingly. In this example, the first and second hashed data are the same as each other, and the distinction between the first and second hashed data is made to indicate that they are derived at different stages of the example method 400.

As such, in this example, the input data (namely, the e-mail address) is known to at least one entity in addition to the first service provider apparatus 303. For example, the input data is also known to the user of the user device 301. This differs from the input data being known only to the first service provider apparatus 303. Where, for example, the e-mail address were combined with a unique secret known only to the first service provider apparatus 303 and the combined data were used as input data, such input data (as a whole) would be considered to be known only by the first service provider apparatus 303. In such an example, the input data (as a whole) would not be known to the user of the user device 301, for example, since the unique secret component of the input data would be known only to the first service provider apparatus 303 and not also to the user of the user device 301.

In this example, the first service provider apparatus 303 receives the e-mail address and the domain name from the user device 301 via the network 305 (item S4f), transmits the DNS query to the authoritative name server 302 via the network 305 (item S4g) and receives the response to the DNS query from the authoritative name server 302 via the network 305 (item S4h). It will be appreciated that the first service provider apparatus 303 can use different connections for communications with the user device 301 and the authoritative name server 302 with such communications taking place via the network 305. Different connections may correspond to different communications protocols being used, different physical and/or logical parts of the network 305 being used, etc.

At item S4j, the first service provider apparatus 303 checks whether the response received at item S4h comprises matching hashed data to that generated at item S4i. The first service provider apparatus 303 may, for example, compare the first hashed data comprised in the response of item S4h to the second hashed data generated at item S4i and determine that the first and second hashed data match where the first and second hashed data are the same. In this example, the response received at item S4h comprises the first hashed data, which is the same as the second hashed data, so the result of the check at item S4j is that the first and second hashed data match.

At item S4k, the first service provider apparatus 303 determines whether or not the verification is successful based on the result of the check at item S4j. In this example, the response of item S4h therefore enables the recipient of the response (in this example, the first service provider apparatus 303) to determine the result of the verification associated with the domain name In this example, the result of the verification is that verification is successful. As indicated above, in this example, the verification is based further on verifying the e-mail address. In other examples, the result of the verification could be that verification is unsuccessful.

Items S4l to S4r correspond closely to items S4e to S4k respectively, except that the verification is performed by the second service provider apparatus 304 instead of the first service provider apparatus 303. In particular, at items S4l and S4m, the user device 301 obtains and transmits the e-mail address and domain name to the second service provider apparatus 304 via the network 305. At item S4n, the second service provider apparatus 304 transmits a DNS query to the authoritative name server 302 via the network 305. At item S4o, the authoritative name server 302 transmits a response to the second service provider apparatus 304 via the network 305 (assuming a previous response to a DNS query for the domain name has not been cached elsewhere in the network 305). At item S4p, the second service provider apparatus 304 hashes the e-mail address using SHA-1, which maps “username@example.com” to “59614f92093fc9fef50673bc160fd808623b17bd”. As such, both the first and second service provider apparatuses 303, 304 map the same input data, namely “username@example.com”, to the same hashed data, namely “59614f92093fc9fef50673bc160fd808623b17bd”, using the same hash function, namely SHA-1. At item S4q, the second service provider apparatus 304 checks whether the response received at item S4o comprises matching hashed data. In this example, the response received at item S4o comprises matching hashed data, so the result of the check at item S4q is that the hashed data matches and, at item S4r, the second service provider 304 determines that the verification is successful based on the result of the check at item S4q.

As such, in this example, the authoritative name server 302 receives (at item S4g), from the first service provider apparatus 303 associated with the first service provider, a first domain name system query comprising a domain name (namely, “example.com”). The authoritative name server 302 transmits (at item S4h), to the first service provider apparatus 303, a first response in response to the first domain name system query. The first response comprises verification data (namely, the first hashed data). The verification data (namely, the first hashed data) has been derived deterministically (in this example, using SHA-1) based on: (i) an identifier (namely, in this example, the e-mail address) associated with an entity associated with the domain name and/or (ii) data provided by an entity associated with the domain name to another entity (examples of such data are provided below). The authoritative name server 302 receives (at item S4n) from the second, different service provider apparatus 304 associated with the second, different service provider, a second domain name system query comprising the domain name (namely, example.com). The authoritative name server 302 transmits (at item S4o), to the second service provider apparatus 304, a second response in response to the second domain name system query. The second response also comprises the verification data (namely, the first hashed data).

It will be understood that this example differs from known, service-provider-led techniques in which each service provider provides a user with a service-provider-specific authorization code and requests the user to store each such authorization code in a zone file for the domain name In contrast, in this example, the storage of the verification data is user-led. In particular, in this example, the user has caused the verification data to be stored in the zone file before the first and second service provider apparatuses 303, 304 have generated the second data. The user may, for example, cause the verification data to be stored by editing the zone file once and may then enable multiple different verifying entities to perform verification without having to edit the zone file again. This is achieved, in this example, by the user providing the first and second service provider apparatuses 303, 304 with the input data to be used by the first and second service provider apparatuses 303, 304 to derive the verification data stored in the zone file. This differs from verifying entities providing the user with authorization codes to be stored in the zone file, particularly where different verifying entities provide different authorization codes.

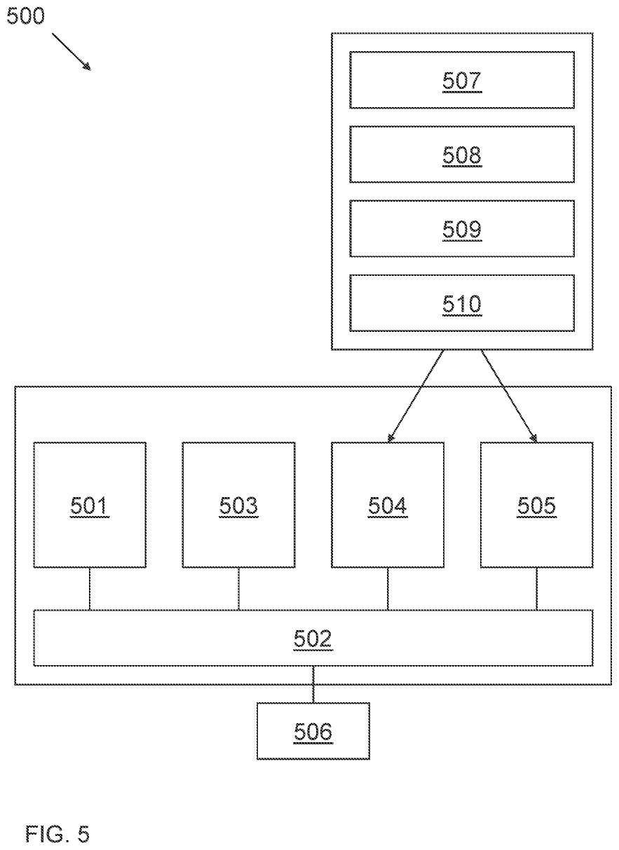

Referring to FIG. 5, there is shown a block diagram of an apparatus 500. The apparatus is configured to process data. Such data processing may involve performing verification associated with a domain name and/or enabling such verification to be performed. The apparatus 500 may, for example, comprise one or more of the apparatuses 301, 302, 303, 304 described above with reference to FIG. 3.

The apparatus 500 may take various different forms. Examples of forms of the apparatus 500 include, but are not limited to, mobile telephony device, a satellite navigation system, a smart television set, a desktop computer, a laptop computer, a server, a name server, a tablet computing device, a router etc.

In this example, the apparatus 500 comprises one or more processors 501 configured to process information and/or instructions. The one or more processors 501 may comprise a central processing unit (CPU). The one or more processors 501 are coupled with a bus 502. Operations performed by the one or more processors 501 may be carried out by hardware and/or software.

In this example, the apparatus 500 comprises computer-useable volatile memory 503 configured to store information and/or instructions for the one or more processors 501. The computer-useable volatile memory 503 is coupled with the bus 502. The computer-useable volatile memory 503 may comprise random access memory (RAM).

In this example, the apparatus 500 comprises computer-useable non-volatile memory 504 configured to store information and/or instructions for the one or more processors 501. The computer-useable non-volatile memory 504 is coupled with the bus 502. The computer-useable non-volatile memory 504 may comprise read-only memory (ROM).

In this example, the apparatus 500 comprises one or more data-storage units 505 configured to store information and/or instructions. The one or more data-storage units 505 are coupled with the bus 502. The one or more data-storage units 505 may for example comprise a magnetic or optical disk and disk drive.

In this example, the apparatus 500 comprises one or more input/output (I/O) devices 506 configured to communicate information to the one or more processors 501. The one or more I/O devices 506 are coupled with the bus 502. The one or more I/O devices 506 may comprise at least one network interface. The at least one network interface may enable the apparatus 500 to communicate via one or more data communications networks. Examples of data communications networks include, but are not limited to, the Internet, a Local Area Network (LAN) and a wide area network (WAN). The one or more I/O devices 506 may enable a user to provide input to the apparatus 500 via one or more input devices (not shown). Examples of input devices include, but are not limited to, a keyboard and a mouse. The one or more I/O devices 506 may enable information to be provided to a user via one or more output devices (not shown). Examples of output devices include, but are not limited to, a computer monitor and a display screen.

Various other entities are depicted for the apparatus 500. For example, when present, an operating system 507, a data processing system 508, one or more modules 509, and data 510 are shown as residing in one, or a combination, of the computer-usable volatile memory 503, computer-usable non-volatile memory 504 and the one or more data-storage units 505. The data processing system 508 may be implemented by way of computer program code stored in memory locations within the computer-usable non-volatile memory 504, computer-readable storage media within the one or more data-storage units 505 and/or other tangible computer-readable storage media.

Although at least some aspects of the examples described herein with reference to the drawings comprise computer processes performed in processing systems or processors, examples described herein also extend to computer programs, for example computer programs on or in a carrier, adapted for putting the examples into practice. The carrier may be any entity or device capable of carrying the program.

It will be appreciated that the apparatus 500 may comprise more, fewer and/or different components from those depicted in FIG. 5.

The above embodiments are to be understood as illustrative examples. Further embodiments are envisaged.

In examples described above, the user device 301 hashes the e-mail address at item S4b and causes the hashed data to be stored by the authoritative name server 302 at items S4c and S4d. In other examples, the e-mail address is hashed outside of the user device 301. For example, the hosting company for the domain name may enable the user to provide the e-mail address to the hosting company and the hosting company may generate and store the hashed data in the zone file for the domain name on behalf of the user. In some such examples, the user may not use the user device 301 to cause the hashed data to be stored in the zone file for the domain name. For example, the user may be able to contact the hosting company without using the user device 301 and request the hosting company to store the hashed data in the zone file for the domain name. The user may provide the hosting company with the e-mail address and/or the hashed data (and/or other input data). The user may, alternatively or additionally, be able to provide the Registrar of the domain name with the e-mail address (and/or other input data) during registration of the domain name with the Registrar, and the Registrar may be able to populate the zone file for the domain name with the hashed data on behalf of the user when registering the domain name.

In examples described above, the first service provider apparatus 303 verifies the e-mail address in response to being provided with the e-mail address at item S4f. However, the first service provider apparatus 303 may verify that the user is in control of the e-mail address (and/or any other contact information) in a different manner. For example, the first service provider apparatus 303 may verify that the user is in control of the e-mail address in response to receiving the response at item S4h, or otherwise.

In examples described above, the contact information is hashed (at items S4i and S4p) after the response is received from the authoritative name server 302 for the domain name (at items S4h and S4o). In other examples, the contact information is hashed before the response is received from the authoritative name server 302 for the domain name.

In examples described above, the example e-mail address (username@example.com) includes the example domain name (example.com). However, the domain name component of the e-mail address may be different from the domain name in association with which verification is performed in other examples. For example, an example e-mail address (username@example.com) may be used to perform verification in association with another domain name (for example, “anotherexample.com”).

In examples described above, receipt of the e-mail address and the domain name by the first service provider apparatus 303 at item S4f triggers the first service provider apparatus 303 to transmit the DNS query of S4g. In other examples, the first service provider apparatus 303 transmits the DNS query of S4g in response to a different trigger. For example, the first service provider apparatus 303 may receive the e-mail address (username@example.com) and another domain name (for example, “anotherexample.com”) from the user device 301. The first service provider apparatus 303 may initially perform a DNS query for the other domain name (anotherexample.com) and receive a response to that DNS query indicating that the first service provider apparatus 303 should perform a further DNS query for the domain name “example.com”. The first service provider apparatus 303 can then perform the further DNS query to obtain the first data described herein. For example, an entity associated with the other domain name (anotherexample.com) may have added a resource record to the zone file for the other domain name (anotherexample.com) indicating that verification data for the other domain name (anotherexample.com) is available at the domain name “example.com”. This may facilitate scalability where an entity has a large number of domain names. For example, respective zone files for the various domain names can, in effect, point to a zone file, for example a single zone file, in which verification data related to all of the domain names is stored.

In examples described above, at items S4c and S4d, the user device 301 causes all of the hashed data derived from the input data to be stored by the authoritative name server 302 in a zone file for the domain name. In other examples, only part of the hashed data is stored. The data that is stored is, however, still considered to be hashed data and may correspond to the first hashed data described herein. For example, a predetermined number of characters of the hashed data may be stored instead of the entire hashed data. Similarly, in examples described above, at items S4i and S4j, the first service provider apparatus 303 hashes the e-mail address and checks whether the entire hash of the e-mail address matches the hashed data comprised in the response of item S4h. In other examples, the first service provider apparatus 303 checks whether a predetermined number of characters of the hashed data matches the hashed data comprised in the response of item S4h. As such, hashed data is still matched with hashed data comprised in the response of item S4j. In such an example, the first service provider apparatus 303 still uses a hash function to map input data to hashed data and determines the verification result based on a comparison involving the resulting hashed data. The entire hashed data resulting from the mapping of the input data or the partial hashed data (being only part of the entire hashed data) may correspond to the second hashed data described herein.

In examples described above, at item S4i, the first service provider apparatus 303 hashes the input data using the same hash function as that used by the user device 301. In some examples, the first service provider apparatus 303 may not know which hash function was used by the user device 301. In some such examples, the first service provider apparatus 303 may hash the input data using multiple hash functions and determine the result of the verification depending on whether or not any of the hashed data resulting from the multiple hash functions matches the hashed data in the zone file.

In examples described above, the hashed data is stored in a zone file for the domain name in association with which verification is being performed. In other examples, the domain name in association with which verification is being performed is a first domain name and the hashed data (and/or other verification data) is stored in a zone file for a second, different domain name. In such examples, the DNS query is for the second domain name, rather than for the first domain name. In some such examples, the second domain comprises the first domain name and the DNS query therefore comprises the first domain name. In such an example, the response to the DNS query would be for the second domain name, rather than for the first domain name, and would comprise both the first and second domain names In such an example, the hashed data is from a zone file for the second domain name, rather than from a zone file for the first domain name By storing the hashed data in a zone file for the second domain name, the risk of inadvertently corrupting the zone file for the first domain name is reduced. Further, where the authoritative name server for the second domain name is different from the authoritative name server for the first domain name, the burden on the authoritative name server for the first domain name resulting from the verification described herein being performed may be relieved.

In some examples, the second domain name includes the first domain name and at least one label preceding and/or following the first domain name. As such, verification data for performing verification associated with a first domain name may be stored in a zone file for a second, different domain name, where the second domain name comprises (i) the first domain name and (ii) at least one label preceding the first domain name and/or at least one label following the first domain name.

For example, where the first domain name is “example.com”, the hashed data may be stored in a zone file for an example second domain name “authority.example.com”. In such an example, the second domain name (authority.example.com) includes exactly one label (authority) before the first domain name (example.com). The second domain name could include more than one label preceding the first domain name in other examples. In such an example, instead of the first service provider apparatus 303 transmitting a DNS query for “example.com” at item S4g, the first service provider apparatus 303 would transmit a DNS query for “authority.example.com”. The first service provider apparatus 303 may, for example, be preconfigured to prepend “authority.” to domain names in association with which verification is being performed. As explained above, the authoritative name server for the second domain name may be the authoritative name server 302 (which is the authoritative name server for the first domain name (“example.com”)) or may be a different authoritative name server. Further, the response to the DNS query for the second domain name (“authority.example.com”) may not comprise the SPF data in the zone file for the first domain name (“example.com”). With reference to International patent application no. PCT/GB2016/054051, this example may correspond to the hashed data being stored in an Independent NOM Record. Unlike SPF, in some examples, verification data associated with a domain name is therefore not stored in the root of the domain name. Instead, in this example, the verification data is stored in a sub-domain. The sub-domain may be reserved for verification data, or otherwise. Storing the verification data in this way may help to keep the DNS efficient and uncluttered.

Alternatively or additionally, where the first domain name is “example.com”, the hashed data may be stored in a zone file for an example second domain name “example.com.nomserver.com”. In such an example, the second domain name (example.com.nomserver.com) includes exactly two labels (“nomserver” and “corn”) after the first domain name (example.com). The second domain name could include one, two or more than two labels following the first domain name in other examples. For example, where the first domain name is “example.com”, the second domain name could be “example.com.nomserver” such that the second domain name includes exactly one label following the first domain name In this example, the two labels following the first domain name comprise a label corresponding to a top-level domain name, namely “corn”. In this example, the second domain name comprises a third domain name, namely “nomserver.com”, following the first domain name (example.com). In this example, the third domain name is a resolvable domain name A domain name is resolvable if a DNS query for the domain name results in a DNS response. In such an example, instead of the first service provider apparatus 303 transmitting a DNS query for “example.com” at item S4g, the first service provider apparatus 303 would transmit a DNS query for “example.com.nomserver.com”. The first service provider apparatus 303 may, for example, be configured to add “.nomserver.com” after domain names in association with which verification is being performed. As explained above, the authoritative name server for the second domain name may be the authoritative name server 302 (which is the authoritative name server for the first domain name (“example.com”)) or may be a different authoritative name server. Further, the response to the DNS query for the second domain name (“example.com.nomserver.com”) may not comprise the SPF data in the zone file for the first domain name (“example.com”). With reference to International patent application no. PCT/GB2016/054051, this example may correspond to the hashed data being stored in a Hosted NOM Record.

In another example, where the first domain name is “example.com”, the hashed data may be stored in a zone file for an example second domain name “authority.example.com.nomserver.com”. In such an example, the second domain name (authority.example.com.nomserver.com) includes exactly one label (authority) before and exactly two labels (“nomserver” and “corn”) after the first domain name (example.com).

In examples described above, at items S4j and S4q, the first hashed data is compared to the second hashed data. Such comparison may involve additional data. For example, third hashed data may be stored in a further zone file. The comparison may further involve the third hashed data. For example, the first hashed data may be stored in a zone file for the domain name “authority.example.com”, the second hash data may be derived by the first and/or second service provider apparatus 303, 304 and the third hash data may be stored in a zone file for the domain name “example.com.nomserver.com”.

In examples described above, the input data comprises contact information, such as an e-mail address or telephone number. Another type of contact information is a social media identifier. The input data may, however, take different forms. For example, the input data may comprise bank details. In such an example, a zone file for a domain name may comprise hashed bank details of an entity (for example, an enterprise, an individual etc) associated with the domain name. A relying party may then verify that they have the correct bank details for the entity by performing a DNS query for the domain name, hashing the bank details they have for the entity and comparing the hashed bank details they have generated with those in the response to the DNS query. In such an example, the entity that stores the hashed payment details in the zone file for the domain name is likely to be different from the entity that verifies the bank details. For example, a DNS administrator may store the hashed bank details and a user (for example a customer) wishing to pay the entity may verify the bank details. In another example, a service provider provides a smart address book service by maintaining a database of contact information for a large number of entities, for example companies. Each company can store a hash of their contact information in a zone file for their domain name. In some such examples, the user can contact the service provider with contact information presumed to be for the company and request that the service provider verify the contact information. The service provider can perform a DNS query for the domain name of the company concerned, obtain the hashed contact information stored by the company, hash the contact information provided by the user, and compare the hashed contact information stored by the company with the hash of the contact information provided by the user. In such an example, the user is not asserting control over the contact information, but uses the service provider to verify that the contact information they have for the company is correct. In some examples, a service provider providing the smart address book service may store a hash of contact information for a company (or any other type of entity), intermittently perform a DNS query for the domain name of the company concerned, and check whether hashed data in the response to the DNS query matches the stored hash of the contact information. If the data does not match, the service provider may determine that at least some of the contact information for the company has changed and can act accordingly. Alternatively or additionally, the input data may comprise secret data, such as a password. As such, it will be understood that the relying party (who relies on the result of the verification) may be the same as or different from the entity that causes the hashed data to be stored in the zone file for the domain name. This provides a flexible and versatile framework for verification using the DNS.

In examples described above, the input data includes the e-mail address and no other data. In other examples, the input data may comprise multiple components. For example, the input data may comprise the e-mail address and the telephone number of the user. This may provide a higher degree of security in some examples. The resulting hashed data may also have the same size, irrespective of the size of the input data, such that no additional storage is used in storing the hashed data.

In examples described above, the same input data and, hence, hashed data is used by multiple, different service providers. In other examples, a user could use different input data for different service providers. For example, the user may cause a hash of their e-mail address and also a hash of their telephone number to be stored in a zone file for the domain name. The user may provide the e-mail address to one service provider and their telephone number to another service provider. Both service providers would be able to perform validation successfully in association with the domain name, and the user would have a higher level of security in relation to the input data. However, this would increase the amount of data stored in the zone file for the domain name.

Various measures (for example, methods, apparatuses, computer programs and computer-readable media) are provided to enable a hierarchical domain name system (for example, the DNS) to be used in performing verification associated with a domain name A domain name system query comprising the domain name is transmitted via a network. The domain name system query may be for the domain name, or may be for a different domain but may nevertheless comprise the domain name. The domain name system query may comprise other data, such as a TXT-type identifier. A response to the domain name system query comprising first data is received via the network. The first data may or may not comprise hashed data. For example, if hashed data has not been stored in a zone file for the domain name, the response may not comprise hashed data. The response may be based on one or more TXT-type resource records. The response may comprise the domain name and/or other data. The other data may comprise SPF data, for example. The domain name system query (in response to which the response is received) may not comprise the first data. Input data is received via the network. The input data may be received before or after the domain name system query is transmitted and may be received before or after the response to the domain name system query comprising first data is received. A hash function is used to map the input data received via the network to second data, the second data comprising hashed data. The input data can take various different forms depending, for example, on the type of data to be verified. Examples such as contact information and bank details are described herein, but other types of input data may be used. The input data may be non-secret data, namely data that is publicly known. The input data may be known by multiple entities. A result of a verification associated with the domain name is determined based on a comparison involving the first data and the second data. The comparison may involve additional data, in addition to the first and second data. The result of the verification may be positive (corresponding to successful verification), or negative (corresponding to unsuccessful verification), or otherwise.

Performing verification associated with a domain name using a hierarchical domain name system in this manner may be more efficient than performing such verification using a different mechanism. For example, using a hierarchical domain name system may result in less data being processed, less user interaction being involved and/or lower delays than performing such verification using a different mechanism. An example of such another mechanism is adding an HTML comment or meta tag including a random string to a homepage for a domain name, as described above. In addition, hashed data can enable verification data to be used by multiple different service providers while providing security in relation to the input data used to produce the hashed data. The input data is received via the network and can, in effect, be reused as input data for further verification performed by at least one further entity. This differs from the input data not being received via a network and, for example, being generated by a verifying entity solely for use by that verifying entity.

In examples, the input data comprises contact information. Contact information may be relatively private data and, as such, may serve as effective input data for verification purposes. Hashing contact information can preserve privacy in relation to the contact information. Where the hashed data is stored in a publicly accessible system, such as the DNS, such hashing may be particularly effective. Further, contact information may be verified as described herein to enhance further the verification.

In examples, the contact information comprises an e-mail address. An e-mail address may readily be verified and may be relatively private. For example, a user may choose not to publish their e-mail address widely and/or may readily be able to set up a dedicated e-mail address for the purposes of the verification described herein.

In examples, the contact information comprises a telephone number. A telephone number may readily be verified and may be relatively private. For example, a user may choose not to publish their telephone number widely.

In examples, the determining of the result of the verification is based further on verifying the contact information. This can enhance the reliability of the verification. In particular, if a third party were to obtain or guess the contact information and try to impersonate the entity in control of the contact information, the third party would not be able to verify the contact information since, for example, they would not receive a verification e-mail with a verification link if they are not in control of the e-mail address.

In examples, the hash function is a cryptographic hash function. This can provide enhanced security and privacy in relation to the input data which, as described herein, may be sensitive, confidential, secret, personal etc. In particular, a cryptographic hash function makes it difficult to obtain input data from given hashed data, even if the hash function used to hash the input data is known.

In examples, the hash function is SHA-1. SHA-1 may, in examples, provide sufficient security with a reasonable resulting bit-length. A shorter bit-length of SHA-1, for example compared to SHA-2 or SHA-3, can result in more efficient storage and processing of the hashed data.

In examples, the domain name is a first domain name, the domain name system query is for a second, different domain name, and the second domain name comprises the first domain name. This can reduce the likelihood of corruption to a critical zone file associated with the first domain name and/or may relieve burden on an authoritative name server for the first domain in some examples.

In examples, the second domain name comprises at least one label preceding the first domain name. The second domain name may comprise at least two labels preceding the first domain name. This may facilitate storage of the hash data, for example where the entity associated with the first domain can create a sub-domain and edit the zone file of that sub-domain Authority for the sub-domain could be delegated to a name server other than the authoritative name server for the first domain, which may relieve burden on the authoritative name server for the first domain.

In examples, the second domain name comprises one label following the first domain name. The second domain name may comprise at least two labels following the first domain name. This may facilitate storage of the hash data, for example where the entity associated with the first domain cannot readily create a sub-domain and/or cannot readily edit the zone file of a sub-domain. Authority for the sub-domain could be delegated to a name server other than the authoritative name server for the first domain, which may relieve burden on the authoritative name server for the first domain.

In examples, an authoritative name server for the first domain name is different from an authoritative name server for the second domain name. This can reduce the burden on the authoritative name server for the first domain name.

In examples, the first data is from a zone file for the second domain name. This can help preserve the integrity of the zone file for the first domain name, which may be critical to proper functioning of the first domain name.

In examples, a zone file for the first domain name comprises SPF data. This can help preserve the SPF data for the first domain name In addition, by separating out the SPF data and the hashed data, the SPF may not be communicated in relation to the verification described herein and the hashed data may not be communicated in relation to other queries in the domain name system. This can result in more efficient processing in the domain name system in both situations in view of the smaller amount of data being processed.

In examples, the response does not comprise SPF data. This can provide more efficient processing in relation to the verification, since data that is not used for the verification is not processed.

In examples, the domain name system query comprises a request for a TXT type of resource record only. This can provide efficient processing in that only data used for the verification is requested and retrieved.

In examples, the first data comprises hashed data. This can enable successful verification.

In examples, the input data comprises bank details. As such, transactional mistakes and/or fraud may be managed. In particular, where verification fails the bank details being verified may be checked and/or queried.

Various measures (for example, methods, apparatuses, computer programs and computer-readable media) are provided in which a domain name system query comprising a domain name is received via a network. A response to the domain name system query is transmitted via the network. The response comprises first data to enable a recipient of the response to determine a result of a verification associated with the domain name based on a comparison involving the first data and second data. The second data is obtained by using a hash function to map input data received via the network to the second data, the second data comprising hashed data. The input data may have been received via the network by the recipient of the response.

This can enable verification as described herein to be performed.

In some examples, the domain name system query is received from a first service provider apparatus and the response is transmitted to the first service provider apparatus. A domain name system query comprising the domain name is received from a second, different service provider apparatus. A response to the domain name system query received from the second service provider apparatus is transmitted to the second service provider apparatus. The response message transmitted to the second service provider apparatus comprises the first hashed data. This can enable the use of shared verification data as described herein. This can provide more efficient and/or scalable verification using the domain name system.

Various measures (for example, methods, apparatuses, computer programs and computer-readable media) are provided in which a domain name system query comprising a domain name is transmitted. In response to the domain name system query, a response comprising shared verification data is received. The shared verification data comprised in the response is not comprised in the domain name system query and the shared verification data comprises hashed data. The hashed data may, for example, be used to perform verification associated with the domain name, or otherwise. This enables shared verification data to be obtained via the domain name system. Shared verification data can facilitate scalability, can make the domain name system more efficient and less cluttered than where non-shared verification data is used, and can reduce the risk of errors to records in the domain name system.

Various measures (for example, methods, apparatuses, computer programs and computer-readable media) are provided in which verification data (for example, hashed data) for performing verification associated with a first domain name is stored in a zone file for a second, different domain name. The second domain name comprises (i) the first domain name; and (ii) at least one label preceding the first domain name and/or at least one label following the first domain name. This can preserve the integrity of the zone file for the first domain while still allowing verification to be performed using the domain name system and can reduce burden on an authoritative name server for the first domain name in some examples.

Various measures (for example, methods, apparatuses, computer programs and computer-readable media) are provided in which contact information associated with an entity associated with a domain name is mapped onto hashed data using a hash function. The hashed data is caused to be stored as verification data in a zone file for the domain name. The hashed data may be used for verification purposes, as described herein, or otherwise, while providing a degree of security and/or privacy in relation to the contact information.

Various measures (for example, methods, apparatuses, computer programs and computer-readable media) are provided in which a first domain name system query comprising a domain name is received from a first service provider apparatus. A first response is transmitted to the first service provider apparatus in response to the first domain name system query. The first response comprises verification data. The verification data has been derived deterministically based on: (i) an identifier associated with an entity associated with the domain name; and/or (ii) data provided by the entity associated with the domain name to another entity. A second domain name system query comprising the domain name is received from a second, different service provider apparatus. A second response in response to the second domain name system query is transmitted to the second service provider apparatus. The second response comprises the verification data. As such, verification may be made more efficient through the use of shared verification data and deterministically derived verification data, as described herein.

Various measures (for example, methods, apparatuses, computer programs and computer-readable media) are provided in which a domain name and input data are obtained, and it is determined whether or not a response to a domain name system query comprising the domain name comprises hashed data matching a hash of the input data. This may, for example, enable verification to be performed via the domain name system.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A method of performing verification associated with a domain name using a hierarchical domain name system, the method comprising:
transmitting, via a network, a domain name system query comprising the domain name;
receiving, via the network, a response to the domain name system query, the response comprising first data;
receiving, via the network, input data;
using a hash function to map the input data received via the network to second data, the second data comprising hashed data; and
determining a result of a verification associated with the domain name based on a comparison involving the first data and the second data,
wherein the domain name is a first domain name, wherein the domain name system query is for a second, different domain name, and wherein the second domain name comprises the first domain name.

2. A method according to claim 1, wherein the input data comprises contact information and wherein the second data is generated by hashing the input data.

3. A method according to claim 2, wherein the contact information comprises an e-mail address.

4. A method according to claim 2, wherein the contact information comprises a telephone number.

5. A method according to claim 2, wherein the determining of the result of the verification is based further on verifying the contact information.

6. A method according to claim 1, wherein the hash function is a cryptographic hash function.

7. A method according to claim 6, wherein the hash function is SHA-1.

8. A method according to claim 1, wherein the second domain name comprises at least one label preceding the first domain name.

9. A method according to claim 1, wherein the second domain name comprises at least one label following the first domain name.

10. A method according to claim 1, wherein an authoritative name server for the first domain name is different from an authoritative name server for the second domain name.

11. A method according to claim 1, wherein the first data is from a zone file for the second domain name.

12. A method according to claim 1, wherein a zone file for the first domain name comprises Sender Policy Framework, SPF, data.

13. A method according to claim 1, wherein the response does not comprise SPF data.

14. A method according to claim 1, wherein the domain name system query comprises a request for a TXT type of resource record only.

15. A method according to claim 1, wherein the first data comprises hashed data.

16. An apparatus comprising:
one or more processors; and
at least one of a computer-useable non-volatile memory and a data storage unit configured to store computer-executable instructions that, when executed by the one or more processors, cause the one or more processors to perform a method of performing verification associated with a domain name using a hierarchical domain name system, the method comprising:
transmitting, via a network, a domain name system query comprising the domain name;
receiving, via the network, a response to the domain name system query, the response comprising first data;
receiving, via the network, input data;
using a hash function to map the input data received via the network to second data, the second data comprising hashed data; and
determining a result of a verification associated with the domain name based on a comparison involving the first data and the second data,
wherein the domain name is a first domain name, wherein the domain name system query is for a second, different domain name, and wherein the second domain name comprises the first domain name.

17. An apparatus according to claim 16, wherein the input data comprises contact information and the computer-executable instructions, when executed by the one or more processors, further cause the one or more processors to generate the second data by hashing the input data.

18. A non-transitory computer-readable medium comprising computer-executable instructions that, when executed by one or more processors, cause the one or more processors to perform a method of performing verification associated with a domain name using a hierarchical domain name system, the method comprising:
transmitting, via a network, a domain name system query comprising the domain name;
receiving, via the network, a response to the domain name system query, the response comprising first data;
receiving, via the network, input data;
using a hash function to map the input data received via the network to second data, the second data comprising hashed data; and
determining a result of a verification associated with the domain name based on a comparison involving the first data and the second data,
wherein the domain name is a first domain name, wherein the domain name system query is for a second, different domain name, and wherein the second domain name comprises the first domain name.

19. A non-transitory computer-readable medium according to claim 18, wherein the input data comprises contact information and the computer-executable instructions, when executed by the one or more processors, further cause the one or more processors to generate the second data by hashing the input data.
